(19) United States
(12) Patent Application Publication
(10) Pub. No.: US 2025/0289725 A1
(43) Pub. Date: Sep. 18, 2025

(54) METHOD OF PREPARING SODIUM BICARBONATE THROUGH CATALYTIC REACTION

(71) Applicant: SOGANG UNIVERSITY RESEARCH & BUSINESS DEVELOPMENT FOUNDATION, Seoul (KR)

(72) Inventors: Nam-Hwi HUR, Seoul (KR); Jaeyeon KIM, Seoul (KR); Hee Sun PARK, Seoul (KR)

(21) Appl. No.: 19/223,076

(22) Filed: May 30, 2025

Related U.S. Application Data
(63) Continuation-in-part of application No. PCT/KR2023/019697, filed on Dec. 1, 2023.

(30) Foreign Application Priority Data
Dec. 1, 2022 (KR) 10-2022-0165838

(51) Int. Cl. C01D 7/00; B01J 23/46; C01C 1/02

(52) U.S. Cl. CPC C01D 7/00; B01J 23/462; C01C 1/02

(57) ABSTRACT

The present disclosure relates to a method of preparing sodium bicarbonate through catalytic reactions. A method of preparing sodium bicarbonate according to embodiments of the present disclosure compared to the conventional Solvay process enables the rapid production of high-quality sodium bicarbonate.

### CROSS-REFERENCE TO RELATED APPLICATIONS

This application is a continuation in part of PCT Application No. PCT/KR2023/019697, filed on Dec. 1, 2023, which claims priority to Korean Patent Application Number 10-2022-0165838, filed on Dec. 1, 2022, both of which are hereby incorporated by reference in their entirety.

### TECHNICAL FIELD

The present disclosure relates to a method of preparing sodium bicarbonate through catalytic reactions.

### BACKGROUND

Sodium carbonate (Na₂CO₃) is a widely used compound that serves as a raw material for the production of soap, glass, and paper and is commonly used for removing water curing. Sodium carbonate is industrially produced through the Solvay process, which uses sodium chloride (NaCl) and calcium carbonate (CaCO₃) as raw materials. The Solvay process includes a process of saturating a highly concentrated sodium chloride solution with an ammonia gas and allowing carbon dioxide to pass through the solution to obtain sodium bicarbonate as precipitate; and a process of heating the obtained sodium bicarbonate to obtain sodium carbonate. The sodium chloride solution is ammoniated brine and serves as a mother liquor.

The Solvay process is an energy-intensive process and thus entails high energy cost. In particular, during the decomposition process where calcium carbonate is sintered at around 1,000° C. to produce carbon dioxide and calcium oxide (CaO), an energy of 2.2 GJ to 2.8 GJ is required per ton of calcium carbonate. Also, about 30% of the highly concentrated sodium chloride solution (300 g/L) remains unreacted in the solution, and calcium chloride (CaCl₂), which has limited industrial uses, is generated in large quantities as a byproduct.

Although ammonia used as a catalyst in the Solvay process can be regenerated and reused after the reaction, a significant amount of ammonia needs to be replenished, which increases the overall cost of the process. Further, the reaction time exceeds 10 hours, which necessitates large-scale equipment for the mass production of sodium bicarbonate. Accordingly, there is a need to develop a novel sodium carbonate production process that reduces energy cost, minimizes byproduct formation, and enables faster production rates.

### PRIOR ART LITERATURE

United States Patent Publication No. 5,981,848.

### DISCLOSURE OF THE INVENTION

### Problems to be Solved by the Invention

The present disclosure relates to a method of preparing sodium bicarbonate through catalytic reactions.

However, problems to be solved by the present disclosure are not limited to the above-described problems, and although not described herein, other problems to be solved by the present disclosure can be clearly understood by those skilled in the art from the following descriptions.

### Means for Solving the Problems

A first aspect of the present disclosure provides a method of preparing sodium bicarbonate, comprising: obtaining sodium bicarbonate through catalytic reactions of nitrate ions, sodium ions, carbon dioxide, and hydrogen.

A second aspect of the present disclosure provides a method of preparing sodium bicarbonate, comprising: obtaining sodium bicarbonate through catalytic reactions of a sodium-containing substance, nitric acid or nitrate, carbon dioxide, and hydrogen.

A third aspect of the present disclosure provides a ruthenium oxide catalyst that is used in the method of the first aspect; or the method of the second aspect, represented by Chemical Formula I, and has a monoclinic structure:

HₓRuO₂; [Chemical Formula I]

wherein in Chemical Formula I, 0<x≤4.

### Effects of the Invention

A method of preparing sodium bicarbonate according to embodiments of the present disclosure compared to the conventional Solvay process enables the production of high-quality sodium bicarbonate in a short time.

The method of preparing sodium bicarbonate according to embodiments of the present disclosure enables the production of costly ammonia in a short time.

Unlike the Solvay process, the method of preparing sodium bicarbonate according to embodiments of the present disclosure does not use ammonia and thus enables the production of sodium bicarbonate at a low cost.

The yield of sodium bicarbonate which can be obtained by the method of preparing sodium bicarbonate according to embodiments of the present disclosure may be about 50% or more, about 60% or more, about 70% or more, about 80% or more, about 85% or more, about 90% or more, about 95% or more, about 98% or more, or about 99% or more.

A catalyst used in the method of preparing sodium bicarbonate according to embodiments of the present disclosure does not dissolve or undergoes structural collapse during the reaction, which allows the reaction to be carried out for a long time.

The catalyst used in the method of preparing sodium bicarbonate according to embodiments of the present disclosure can be separated and recovered after the reaction and then can be reused. Thus, it is possible to reduce costs associated with the catalyst.

The method of preparing sodium bicarbonate according to embodiments of the present disclosure can consistently maintain a high yield and a high selectivity, close to atom economy.

The method of preparing sodium bicarbonate according to embodiments of the present disclosure uses captured carbon dioxide as a reactant and thus can reduce about 20 million tons or more of carbon dioxide globally each year.

### BRIEF DESCRIPTION OF THE DRAWINGS

FIG. 1 is a schematic diagram illustrating a reaction for preparing sodium bicarbonate and ammonia through catalytic reactions of nitrate ions, sodium ions, carbon dioxide, and hydrogen according to an embodiment of the present disclosure.

FIG. 2 is a powder X-ray diffraction (PXRD) graph of sodium bicarbonate (NaHCO₃) prepared according to Example 1-1 of the present disclosure.

FIG. 3 is a powder X-ray diffraction (PXRD) graph of sodium carbonate (Na₂CO₃) prepared according to Example 1-1 of the present disclosure.

FIG. 4 is a powder X-ray diffraction (PXRD) graph of ammonium sulfate ((NH₄)₂SO₄) prepared according to Example 1-1 of the present disclosure.

FIG. 5 is a powder X-ray diffraction (PXRD) graph of ruthenium oxide catalyst (HₓRuO₂) prepared according to an embodiment of the present disclosure.

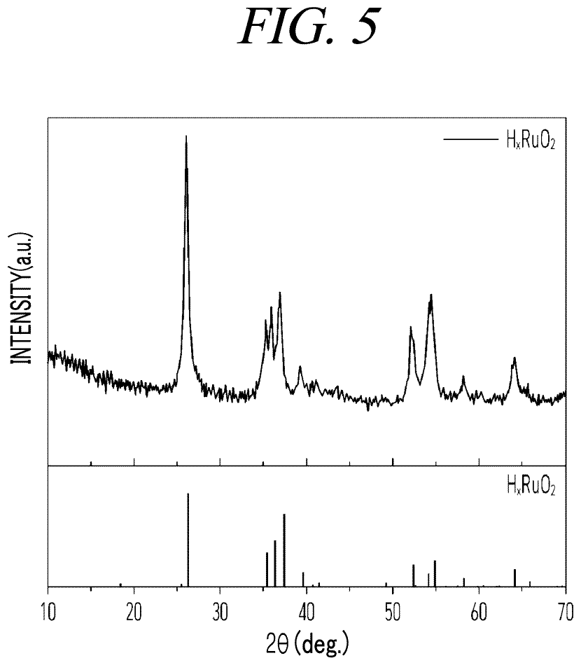

FIG. 6 is a powder X-ray diffraction (PXRD) graph of sodium bicarbonate (NaHCO₃) obtained according to Example 2-1 of the present disclosure.

FIG. 7 is a powder X-ray diffraction (PXRD) graph of barium sulfate (BaSO₄) obtained according to Example 2-1 of the present disclosure.

FIG. 8 is a powder X-ray diffraction (PXRD) graph of ammonium bicarbonate (NH₄HCO₃) prepared according to Example 2-1 of the present disclosure.

FIG. 9 is a powder X-ray diffraction (PXRD) graph of products (NaHCO₃ and Na(NH₄)SO₄·2H₂O) obtained according to Example 2-2 of the present disclosure.

FIG. 10 is a powder X-ray diffraction (PXRD) graph of sodium bicarbonate (NaHCO₃) obtained according to Example 2-3 of the present disclosure.

FIG. 11 is a powder X-ray diffraction (PXRD) graph of silver chloride (AgCl) obtained according to Example 2-3 of the present disclosure.

FIG. 12 is a powder X-ray diffraction (PXRD) graph of products (NaHCO₃, NH₄Cl, and NaCl) obtained according to Example 2-4 of the present disclosure.

FIG. 13 is a powder X-ray diffraction (PXRD) graph of products (NaHCO₃ and NaNO₃) obtained according to Example 2-5 of the present disclosure.

FIG. 14 is a powder X-ray diffraction (PXRD) graph of sodium precipitates (SiO₂ and HₓRuO₂) obtained according to Example 2-5 of the present disclosure.

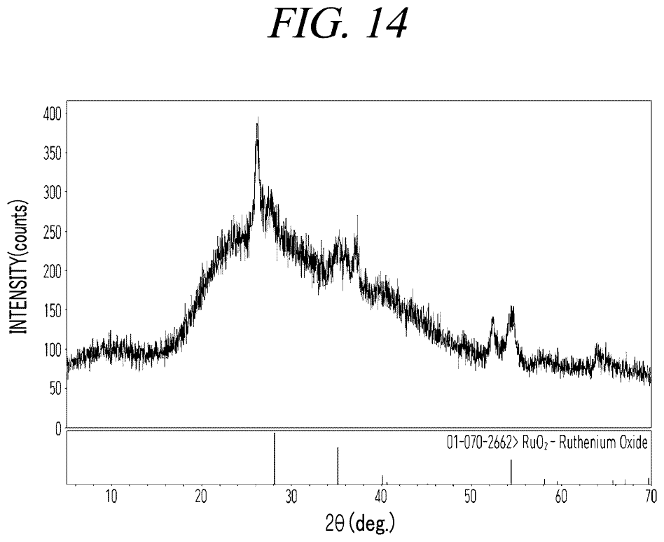

FIG. 15 is a powder X-ray diffraction (PXRD) graph of sodium products (NaHCO₃, Na₂CO₃H₂O, and Na₃H(CO₃)₂(H₂O)₂) obtained according to Example 2-6 of the present disclosure.

FIG. 16 is a powder X-ray diffraction (PXRD) graph of sodium precipitates ((NH₄)₂MoO₄ and HₓRuO₂) obtained according to Example 2-6 of the present disclosure.

### BEST MODE FOR CARRYING OUT THE INVENTION

Hereinafter, embodiments and examples of the present disclosure will be described in detail with reference to the accompanying drawings so that the present disclosure may be readily implemented by those skilled in the art. However, it is to be noted that the present disclosure is not limited to the examples but can be embodied in various other ways. In drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element.

Through the whole document, the term “on” that is used to designate a position of one element with respect to another element includes both a case that the one element is adjacent to the other element and a case that any other element exists between these two elements.

Through the whole document, the term “comprises or includes” and/or “comprising or including” used in the document means that one or more other components, steps, operation and/or existence or addition of elements are not excluded in addition to the described components, steps, operation and/or elements unless context dictates otherwise.

Through the whole document, the term “about or approximately” or “substantially” is intended to have meanings close to numerical values or ranges specified with an allowable error and intended to prevent accurate or absolute numerical values disclosed for understanding of the present disclosure from being illegally or unfairly used by any unconscionable third party.

Through the whole document, the term “step of” does not mean “step for”.

Through the whole document, the term “combination of” included in Markush type description means mixture or combination of one or more components, steps, operations and/or elements selected from a group consisting of components, steps, operation and/or elements described in Markush type and thereby means that the disclosure includes one or more components, steps, operations and/or elements selected from the Markush group.

Through this whole specification, a phrase in the form “A and/or B” means “A or B, or A and B”.

Hereinafter, embodiments of the present disclosure have been described in detail, but the present disclosure may not be limited thereto.

A first aspect of the present disclosure provides a method of preparing sodium bicarbonate, comprising: obtaining sodium bicarbonate through catalytic reactions of nitrate ions, sodium ions, carbon dioxide, and hydrogen.

In an embodiment of the present disclosure, the catalyst may be selected from metals, alloys, or oxides including at least one selected from titanium (Ti), vanadium (V), chromium (Cr), manganese (Mn), iron (Fe), cobalt (Co), nickel (Ni), copper (Cu), zinc (Zn), molybdenum (Mo), indium (In), tin (Sn), phosphorus (P), aluminum (AI), silicon (Si), ruthenium (Ru), rhodium (Rh), palladium (Pd), silver (Ag), tungsten (W), rhenium (Re), osmium (Os), iridium (Ir), platinum (Pt), and gold (Au). In an embodiment of the present disclosure, the catalyst can be ruthenium powder, palladium powder, or ruthenium oxides.

In an embodiment of the present disclosure, the catalyst may include a ruthenium oxide catalyst represented by Chemical Formula I, but is not limited thereto:

HₓRuO₂; [Chemical Formula I]

wherein in Chemical Formula I, 0<x≤4.

In an embodiment of the present disclosure, when the catalyst has a particle size of about 10 nm or less, the reaction activity can be enhanced.

In an embodiment of the present disclosure, the catalyst does not dissolve or undergoes structural collapse during the reaction, so that the reaction can be carried out for a long time.

In an embodiment of the present disclosure, the catalyst can be separated and recovered after the reaction and then can be reused.

In an embodiment of the present disclosure, it is preferable to use a catalyst including ruthenium oxide represented by Chemical Formula I in terms of activity and/or stability, but other metals may be included as cocatalysts.

In an embodiment of the present disclosure, the catalytic reactions are conducted in a hydrothermal reactor, but is not limited thereto.

In an embodiment of the present disclosure, reactants of the catalytic reactions further may include a solvent, but is not limited. In an embodiment of the present disclosure, the solvent may be selected from distilled water, methanol, and ethanol, but is not limited thereto. In an embodiment of the present disclosure, the solvent may be distilled water.

In an embodiment of the present disclosure, when the reactant includes sodium nitrate and a solvent, a weight ratio of the solvent to the sodium nitrate may be about 0:10 to about 100:1, but is not limited thereto.

In an embodiment of the present disclosure, when the reactant includes sodium nitrate, a molar ratio of the catalyst to the sodium nitrate (catalyst:sodium nitrate) may be about 1:5 to about 1:500, but is not limited thereto. In an embodiment of the present disclosure, when the molar ratio of the catalyst to the sodium nitrate is equal to or greater than about 1:500, the reaction time may increase and the reaction may remain incomplete. When the molar ratio of the catalyst to the sodium nitrate is less than about 1:5, the reaction rate may increase, but a large amount of catalyst is required, which makes the process uneconomical.

In an embodiment of the present disclosure, a pressure ratio of the carbon dioxide to the hydrogen (carbon dioxide:hydrogen) may be about 1:1 to about 1:50, about 1:1 to about 1:40, about 1:1 to about 1:30, about 1:1 to about 1:20, about 1:1 to about 1:10, about 1:1 to about 1:5, or about 1:1 to about 1:4, but is not limited thereto. In an embodiment of the present disclosure, the pressure ratio of the carbon dioxide to the hydrogen may be about 1:4.

In an embodiment of the present disclosure, a total pressure of the hydrothermal reactor in which the catalytic reactions are carried out may be about 0.1 MPa to about 20 MPa, but is not limited thereto. The total pressure of the hydrothermal reactor may be about 0.1 MPa to about 20 MPa, about 0.1 MPa to about 15 MPa, about 0.1 MPa to about 10 MPa, about 0.1 MPa to about 5 MPa, about 1 MPa to about 20 MPa, about 1 MPa to about 15 MPa, about 1 MPa to about 10 MPa, about 1 MPa to about 5 MPa, about 2 MPa to about 20 MPa, about 2 MPa to about 15 MPa, about 2 MPa to about 10 MPa, or about 2 MPa to about 5 MPa, but is not limited thereto. In an embodiment of the present disclosure, the total pressure of the hydrothermal reactor may be about 2.5 MPa.

In an embodiment of the present disclosure, the catalytic reactions may be conducted at a temperature of about 20° C. to about 200° C., but is not limited thereto. In an embodiment of the present disclosure, the catalytic reactions may be conducted at a temperature of about 20° C. to about 200° C., about 20° C. to about 170° C., about 20° C. to about 150° C., about 20° C. to about 130° C., about 20° C. to about 110° C., about 20° C. to about 90° C., about 40° C. to about 200° C., about 40° C. to about 170° C., about 40° C. to about 150° C., about 40° C. to about 130° C., about 40° C. to about 110° C., about 40° C. to about 90° C., about 60° C. to about 200° C., about 60° C. to about 170° C., about 60° C. to about 150° C., about 60° C. to about 130° C., about 60° C. to about 110° C., or about 60° C. to about 90° C., but is not limited thereto.

In an embodiment of the present disclosure, when the reactant includes sodium nitrate, the reaction time may vary depending on the molar ratio of the catalyst to the sodium nitrate. In an embodiment of the present disclosure, if the molar ratio of the catalyst to the sodium nitrate is about 1:10 or less, the reaction may be completed within about 1 hour, but the present disclosure is not limited thereto. In an embodiment of the present disclosure, if the molar ratio of the catalyst to the sodium nitrate is about 1:100 or more, the reaction may take more than about 1 hour to complete, but the present disclosure is not limited thereto.

In an embodiment of the present disclosure, reactants of the catalytic reactions further include an additive, but is not limited thereto.

In an embodiment of the present disclosure, the additive may be at least one selected from NaOH, KOH, LiOH, Ba(OH)₂, Ca(OH)₂, RbOH, CsOH, Sr(OH)₂, CH₃NH₂, C₂H₅NH₂, Mg(OH)₂, and Al(OH)₃. In an embodiment of the present disclosure, the additive may be NaOH.

In an embodiment of the present disclosure, when the reactant includes nitric acid, the formation of nitrate ions may be facilitated by adding a basic additive to increase the pH.

In an embodiment of the present disclosure, when the reactant includes sodium nitrate and an additive, a molar ratio of the additive to the sodium nitrate may be about 1:1, but is not limited thereto.

In an embodiment of the present disclosure, the yield of sodium bicarbonate which can be obtained by the catalytic reactions may be about 90% or more. In an embodiment of the present disclosure, the yield of sodium bicarbonate which can be obtained by the catalytic reactions may be about 50% or more, about 60% or more, about 70% or more, about 80% or more, about 95% or more, about 98% or more, or about 99% or more.

In an embodiment of the present disclosure, the obtained sodium bicarbonate may be heat-treated to produce sodium carbonate.

In an embodiment of the present disclosure, the heat treatment may be performed in air, but the present disclosure is not limited thereto.

In an embodiment of the present disclosure, the heat treatment may be performed at a temperature of about 250° C. to about 350° C. In an embodiment of the present disclosure, the heat treatment may be performed at a temperature of about 250° C. to about 350° C., about 250° C. to about 330° C., about 250° C. to about 310° C., about 250° C. to about 290° C., about 250° C. to about 270° C., about 270° C. to about 350° C., about 270° C. to about 330° C., about 270° C. to about 310° C., about 270° C. to about 290° C., about 290° C. to about 350° C., about 290° C. to about 330° C., about 290° C. to about 310° C., 310° C. to about 350° C., about 310° C. to about 330° C., about 330° C. to about 350° C., is not limited thereto.

In an embodiment of the present disclosure, ammonia and/or an ammonium compound may be further prepared by the method of preparing sodium bicarbonate. In an embodiment of the present disclosure, after the catalytic reactions are completed, an acid may be added to the remaining solution to obtain an ammonium compound corresponding to the type of the acid used. In an embodiment of the present disclosure, the acid may be selected from sulfuric acid (H₂SO₄), nitric acid (HNO₃), hydrochloric acid (HCl), acetic acid (CH₃COOH), carbonic acid (H₂CO₃), and formic acid (HCOOH), but is not limited thereto. In an embodiment of the present disclosure, the acid may be a weak or strong acid. In an embodiment of the present disclosure, the acid may be sulfuric acid. In an embodiment of the present disclosure, after the catalytic reactions are completed, sulfuric acid may be added to the remaining solution to obtain ammonium sulfate. In an embodiment of the present disclosure, the ammonium compounds may include at least one selected from NH₄HCO₃, (NH₄)₂SO₄, (NH₄)HSO₄, NH₄NO₃, NH₄Cl, CH₃COONH₄, (NH₄)₂CO₃, and NH₄HCO₃, but is not limited thereto.

In an embodiment of the present disclosure, carbon dioxide may be added to the remaining solution to obtain an ammonium compound. In this case, the ammonium compound may be ammonium bicarbonate (NH₄HCO₃), but is not limited thereto.

In the method of preparing sodium bicarbonate according to an embodiment of the present disclosure, water may be generated as a byproduct.

A second aspect of the present disclosure provides a method of preparing sodium bicarbonate, comprising: obtaining sodium bicarbonate through catalytic reactions of a sodium-containing substance, nitric acid or nitrate, carbon dioxide, and hydrogen.

Detailed descriptions of the second aspect of the present disclosure, which overlap with those of the first aspect of the present disclosure, are omitted hereinafter, but the descriptions of the first aspect of the present disclosure may be identically applied to the second aspect of the present disclosure, even though they are omitted hereinafter.

In an embodiment of the present disclosure, the sodium-containing substance may include at least one selected from sodium salts, sodium-containing composite oxides, and sodium-containing ores, but is not limited thereto.

In an embodiment of the present disclosure, the solubility of the sodium salt in water may not be limited.

In an embodiment of the present disclosure, the sodium salts may include at least one selected from NaNO₃, Na₂SO₄ and NaCl, and the sodium-containing composite oxides and/or the sodium-containing ores may include at least one selected from Na₂SiO₃, Na₂MoO₄, and Na₃VO₄, but is not limited thereto.

In an embodiment of the present disclosure, the nitrate may include at least one selected from Ba(NO₃)₂, Ca(NO₃)₂, Pb(NO₃)₂, and AgNO₃ but is not limited thereto.

In an embodiment of the present disclosure, the catalyst may be selected from metals, alloys, or oxides including at least one selected from titanium (Ti), vanadium (V), chromium (Cr), manganese (Mn), iron (Fe), cobalt (Co), nickel (Ni), copper (Cu), zinc (Zn), molybdenum (Mo), indium (In), tin (Sn), phosphorus (P), aluminum (AI), silicon (Si), ruthenium (Ru), rhodium (Rh), palladium (Pd), silver (Ag), tungsten (W), rhenium (Re), osmium (Os), iridium (Ir), platinum (Pt), and gold (Au), but is not limited thereto.

In an embodiment of the present disclosure, the catalyst may include a ruthenium oxide catalyst represented by Chemical Formula I, but is not limited thereto:

HₓRuO₂; [Chemical Formula I]

wherein in Chemical Formula I, 0<x≤4.

In an embodiment of the present disclosure, when the catalyst has a particle size of about 10 nm or less, the reaction activity can be enhanced.

In an embodiment of the present disclosure, the catalyst does not dissolve or undergoes structural collapse during the reaction, so that the reaction can be carried out for a long time.

In an embodiment of the present disclosure, the catalyst can be separated and recovered after the reaction and then can be reused.

In an embodiment of the present disclosure, it is preferable to use a catalyst including ruthenium oxide represented by Chemical Formula I in terms of activity and/or stability, but other metals may be included as cocatalysts.

In an embodiment of the present disclosure, the catalytic reactions are conducted in a hydrothermal reactor, but is not limited thereto.

In an embodiment of the present disclosure, reactants of the catalytic reactions further include a solvent, but is not limited. In an embodiment of the present disclosure, the solvent may be selected from distilled water, methanol, and ethanol, but is not limited thereto. In an embodiment of the present disclosure, the solvent may be distilled water.

In an embodiment of the present disclosure, a weight ratio of the solvent to the sodium-containing substance (solvent:sodium-containing substance) may be about 0:10 to about 100:1, but is not limited thereto.

In an embodiment of the present disclosure, a molar ratio of the catalyst to the sodium-containing substance (catalyst:sodium-containing substance) may be about 1:5 to about 1:500, but is not limited thereto. In an embodiment of the present disclosure, when the molar ratio of the catalyst to the sodium-containing substance is equal to or greater than about 1:500, the reaction time may increase and the reaction may remain incomplete. When the molar ratio of the catalyst to the sodium-containing substance is less than about 1:5, the reaction rate may increase, but a large amount of catalyst is required, which makes the process uneconomical.

In an embodiment of the present disclosure, the pressure ratio of the carbon dioxide to the hydrogen (carbon dioxide:hydrogen) may be about 1:1 to about 1:50, about 1:1 to about 1:40, about 1:1 to about 1:30, about 1:1 to about 1:20, about 1:1 to about 1:10, about 1:1 to about 1:5, or about 1:1 to about 1:4, but is not limited thereto. In an embodiment of the present disclosure, the pressure ratio of the carbon dioxide to the hydrogen may be about 1:4.

In an embodiment of the present disclosure, a total pressure of the hydrothermal reactor in which the catalytic reactions are carried out may be about 0.1 MPa to about 20 MPa, but is not limited thereto. The total pressure of the hydrothermal reactor may be about 0.1 MPa to about 20 MPa, about 0.1 MPa to about 15 MPa, about 0.1 MPa to about 10 MPa, about 0.1 MPa to about 5 MPa, about 1 MPa to about 20 MPa, about 1 MPa to about 15 MPa, about 1 MPa to about 10 MPa, about 1 MPa to about 5 MPa, about 2 MPa to about 20 MPa, about 2 MPa to about 15 MPa, about 2 MPa to about 10 MPa, or about 2 MPa to about 5 MPa, but is not limited thereto.

In an embodiment of the present disclosure, the catalytic reactions may be conducted at a temperature of about 20° C. to about 200° C., but is not limited thereto. In an embodiment of the present disclosure, the catalytic reactions may be conducted at a temperature of about 20° C. to about 200° C., about 20° C. to about 170° C., about 20° C. to about 150° C., about 20° C. to about 130° C., about 20° C. to about 110° C., about 20° C. to about 90° C., about 40° C. to about 200° C., about 40° C. to about 170° C., about 40° C. to about 150° C., about 40° C. to about 130° C., about 40° C. to about 110° C., about 40° C. to about 90° C., about 60° C. to about 200° C., about 60° C. to about 170° C., about 60° C. to about 150° C., about 60° C. to about 130° C., about 60° C. to about 110° C., or about 60° C. to about 90° C., but is not limited thereto.

In an embodiment of the present disclosure, the reaction time may vary depending on the molar ratio of the catalyst to the sodium-containing substance. In an embodiment of the present disclosure, if the molar ratio of the catalyst to the sodium-containing substance is about 1:10 or less, the reactions may be completed within about 1 hour, but the present disclosure is not limited thereto. In an embodiment of the present disclosure, if the molar ratio of the catalyst to the sodium-containing substance is about 1:100 or more, the reaction may take more than about 1 hour to complete, but the present disclosure is not limited thereto.

In an embodiment of the present disclosure, reactants of the catalytic reactions further include an additive.

In an embodiment of the present disclosure, the additive may be at least one selected from NaOH, KOH, LiOH, Ba(OH)₂, Ca(OH)₂, RbOH, CsOH, Sr(OH)₂, CH₃NH₂, C₂H₅NH₂, Mg(OH)₂, and Al(OH)₃. In an embodiment of the present disclosure, the additive may be NaOH.

In an embodiment of the present disclosure, when the reactant includes a sodium-containing substance and an additive, a molar ratio of the additive to the sodium-containing substance may be about 1:1, but is not limited thereto.

In an embodiment of the present disclosure, the yield of sodium bicarbonate which can be obtained through the catalytic reactions may be about 90% or more. In an embodiment of the present disclosure, the yield of sodium bicarbonate which can be obtained through the catalytic reactions may be about 50% or more, about 60% or more, about 70% or more, about 80% or more, about 85% or more, about 90% or more, about 95% or more, about 98% or more, or about 99% or more.

In an embodiment of the present disclosure, the obtained sodium bicarbonate may be heat-treated to produce sodium carbonate.

In an embodiment of the present disclosure, the heat treatment may be performed in air, but the present disclosure is not limited thereto.

In an embodiment of the present disclosure, the heat treatment may be performed at a temperature of about 250° C. to about 350° C. In an embodiment of the present disclosure, the heat treatment may be performed at a temperature of about 250° C. to about 350° C., about 250° C. to about 330° C., about 250° C. to about 310° C., about 250° C. to about 290° C., about 250° C. to about 270° C., about 270° C. to about 350° C., about 270° C. to about 330° C., about 270° C. to about 310° C., about 270° C. to about 290° C., 290° C. to about 350° C., about 290° C. to about 330° C., 290° C. to about 310° C., 310° C. to about 350° C., 310° C. to about 330° C., 330° C. to about 350° C., is not limited thereto.

In an embodiment of the present disclosure, the method of preparing sodium bicarbonate compared to the conventional Solvay process may enable low-cost and rapid production of high-quality sodium bicarbonate with costly and useful compounds as byproducts. In an embodiment of the present disclosure, the byproducts may include at least one selected from BaSO₄, CaSO₄, AgCl, NaCl, NaNO₃, SiO₂, ammonia, and an ammonium compound, but is not limited thereto. In an embodiment or the present disclosure, the ammonium compound may include NH₄HCO₃, Na(NH₄)SO₄·2H₂O, NH₄Cl, (NH₄)₂SO₄, (NH₄)HSO₄, and (NH₄)₂MoO₄, is not limited thereto.

In an embodiment of the present disclosure, after the catalytic reactions are completed, ammonia and/or an ammonium compound may be obtained from the remaining solution. In an embodiment of the present disclosure, the ammonium compound may be an ammonium salt, but is not limited thereto.

A third aspect of the present disclosure provides a ruthenium oxide catalyst that is used in the method of the first aspect; or the method of the second aspect, represented by Chemical Formula I, and has a monoclinic structure:

HₓRuO₂; [Chemical Formula I]

wherein in Chemical Formula I, 0<x≤4.

Detailed descriptions of the third aspect of the present disclosure, which overlap with those of the first aspect and the second aspect of the present disclosure, are omitted hereinafter, but the descriptions of the first aspect and the second aspect of the present disclosure may be identically applied to the third aspect of the present disclosure, even though they are omitted hereinafter.

In an embodiment of the present disclosure, x (the atomic ratio of hydrogen) in Chemical Formula I may be greater than 0 to 4 or less, about 0.1 to about 3.5, about 0.1 to about 3, about 0.1 to about 2.5, about 0.1 to about 2, about 0.1 to about 1.5, about 0.1 to about 1.2, about 0.2 to about 3.5, about 0.2 to about 3, about 0.2 to about 2.5, about 0.2 to about 2, about 0.2 to about 1.5, about 0.2 to about 1.2, about 0.3 to about 3.5, about 0.3 to about 3, about 0.3 to about 2.5, about 0.3 to about 2, about 0.3 to about 1.5, about 0.3 to about 1.2, about 0.4 to about 3.5, about 0.4 to about 3, about 0.4 to about 2.5, about 0.4 to about 2, about 0.4 to about 1.5, or about 0.4 to about 1.2, but is not limited thereto.

In an embodiment of the present disclosure, as x (the atomic ratio of hydrogen) in Chemical Formula I is close to about 1, it may be easier to produce the monoclinic ruthenium oxide. Specifically, when the hydrogen ratio is about 0.6 to about 1.4, it may be easier to produce the monoclinic ruthenium oxide. Herein, when x in Chemical Formula I is 0, a structural transition to tetragonal rutile-type ruthenium oxide may occur. Thus, it is preferable to maintain the hydrogen content.

In an embodiment of the present disclosure, the atomic ratio of hydrogen included in Chemical Formula I may be calculated by thermogravimetric analysis (TGA). Specifically, in the TGA, a solid sample is placed in a platinum container, and weight changes are measured as the temperature increases. Hydrogen included in the monoclinic ruthenium oxide (HₓRuO₂) is completely removed and converted into tetragonal ruthenium oxide (RuO₂). The amount of hydrogen can be quantitatively analyzed based on weight changes with temperature.

In an embodiment of the present disclosure, diffraction peaks of the ruthenium oxide may be observed at respective positions corresponding to incident angles (2θ) of 18.38°<2θ<18.42°, 25.45°<2θ<25.51°, 26.26°<2θ<26.32°, 33.45°<2θ<33.51°, 35.28°<2θ<35.34°, 36.24°<2θ<36.30°, 37.32°<2θ<37.38°, 39.55°<2θ<39.61°, 40.61°<2θ<40.67°, 41.46°<2θ<41.52°, 49.17°<2θ<49.23°, 52.31°<2θ<52.37°, 54.03°<2θ<54.09°, 54.70°<2θ<54.76°, 55.95°<2θ<56.01°, 59.97°<2θ<60.03°, 60.40°<2θ<60.46°, 61.92°<2θ<61.98°, 63.94°<2θ<64.00°, 65.79°<2θ<65.85°and 69.13°<2θ<69.19° as determined by X-ray powder diffraction measurement (Cu Kα rays). In an embodiment of the present disclosure, diffraction peaks of the ruthenium oxide may be observed at respective positions corresponding to incident angles (2θ) of 18.40°, 25.48°, 26.29°, 33.48°, 35.31°, 36.27°, 37.35°, 39.58°, 40.64°, 41.49°, 49.20°, 52.34°, 54.06°, 54.73°, 55.98°, 58.00°, 60.43°, 61.95°, 63.97°, 65.82° and 69.16° as determined by X-ray powder diffraction measurement (Cu Kα rays).

In an embodiment of the present disclosure, the ruthenium oxide may have a structure of a monoclinic space group P2₁/c, C2/m, P2/c, C2/c, P2/m or P2₁/m, but this It is not limited thereto.

In an embodiment of the present disclosure, a unit cell of the monoclinic crystal structure of the ruthenium oxide may be represented as shown in the figure below, and lattice constants a to c and an angle between the edges may be defined as follows.

In an embodiment of the present disclosure, the monoclinic structure may have lattice constants of 5 Å≤a≤6 Å, 5 Å≤b≤6 Å and 5 Å≤c≤6 Å, and a beta (β) angle may be about 110° to about 120°. For example, each of the a and the c may be about 5 Å to about 6 Å, about 5.1 Å to about 6 Å, about 5.2 Å to about 6 Å, about 5.3 Å to about 6 Å, about 5 Å to about 5.8 Å, about 5.1 Å to about 5.8 Å, about 5.2 Å to about 5.8 Å, about 5.3 Å to about 5.8 Å, about 5 Å to about 5.6 Å, about 5.1 Å to about 5.6 Å, about 5.2 Å to about 5.6 Å, about 5.3 Å to about 5.6 Å, about 5 Å to about 5.4 Å, about 5.1 Å to about 5.4 Å, about 5.2 Å to about 5.4 Å, about 5.3 Å to about 5.4 Å, or about 5.35 Å to about 5.4 Å, the b may be about 5 Å to about 6 Å, about 5 Å to about 5.8 Å, about 5 Å to about 5.6 Å, about 5 Å to about 5.4 Å, about 5 Å to about 5.2 Å, or about 5 Å to about 5.1 Å, and the beta (β) angle may be about 110° to about 120°, about 112° to about 120°, about 114° to about 120°, about 110° to about 118°, about 112° to about 118°, about 114° to about 118°, about 110° to about 116°, about 112° to about 116°, or about 114° to about 116°.

In an embodiment of the present disclosure, the monoclinic structure may have lattice constants of a=5.3533 Å, b=5.0770 Å, and c=5.3532 Å, and a beta (β) angle of 115.9074°, but is not limited thereto.

### MODE FOR CARRYING OUT THE INVENTION

### EXAMPLES

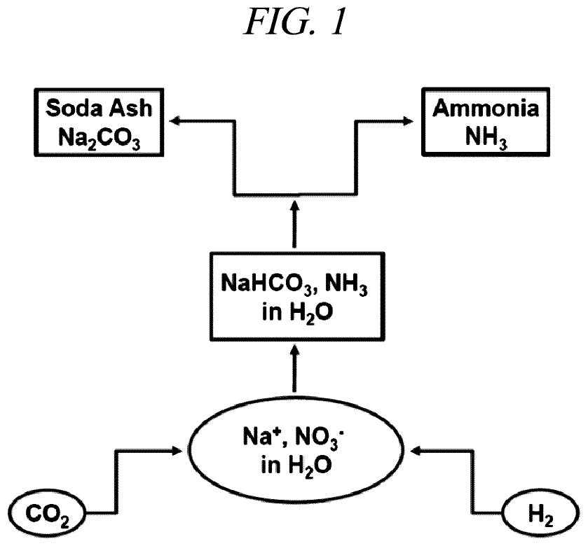

### Example 1-1 (FIG. 1)

After 10 mg (0.075 mmol) of HₓRuO₂, 0.15 g (1.76 mmol) of sodium nitrate, and 0.5 mL of distilled water were placed in a hydrothermal reactor, the hydrothermal reactor was filled with carbon dioxide at a pressure of 0.5 MPa and hydrogen at a pressure of 2.0 MPa and the reactions were conducted at 100° C. for 1 hour. After the reactions were completed, the hydrothermal reactor was cooled to room temperature, and the resulting precipitates and the remaining solution were separated.

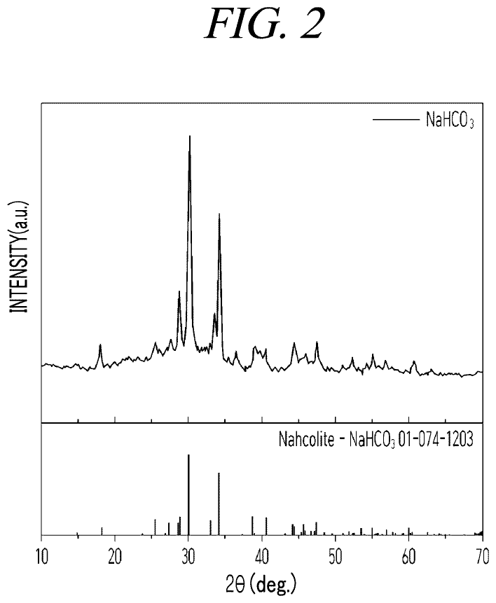

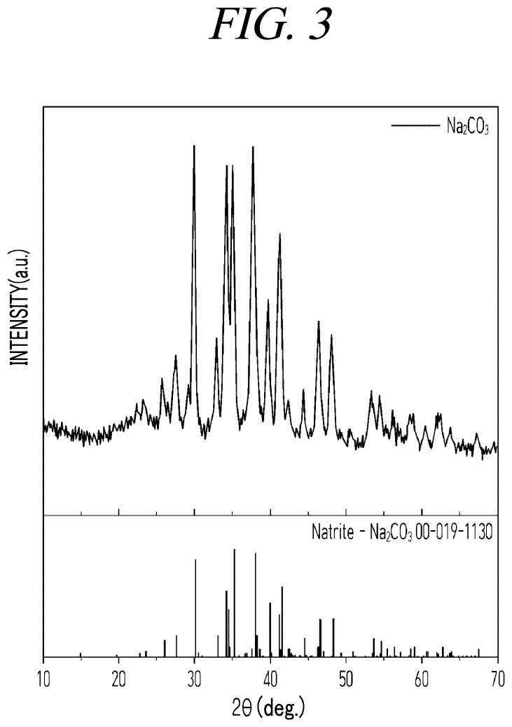

Referring to FIG. 2, the precipitate containing the separated HₓRuO₂ catalyst was identified as sodium bicarbonate (NaHCO₃) by powder X-ray diffraction (PXRD) analysis. The amount of sodium bicarbonate obtained was 0.142 g (1.69 mmol), and the yield of sodium bicarbonate was calculated to be 96.0% based on sodium nitrate. The sodium bicarbonate powder was heat-treated at 300° C. and then converted into sodium carbonate, which was confirmed by PXRD analysis (see FIG. 3). The yield of sodium carbonate was 99% or more.

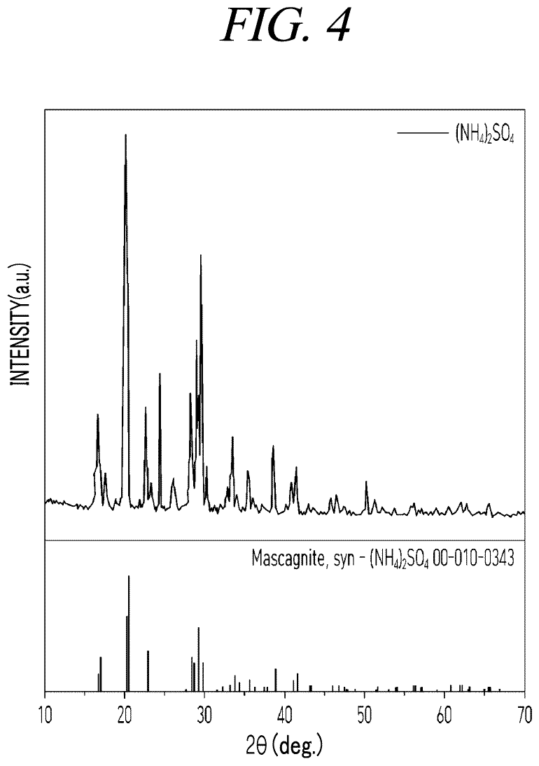

The remaining solution was analyzed by ultraviolet-visible (UV-vis) spectroscopy, and no nitrate ions (NO₃⁻ and NO₂⁻) were detected, which indicates that all nitrate ions in the reactant were converted into ammonia or nitrogen. Sulfuric acid and acetone were added to the remaining solution, followed by separation and drying to obtain white powder. The white powder was identified as ammonium sulfate ((NH₄)₂SO₄) by PXRD analysis (see FIG. 4). The amount of ammonium sulfate obtained was 0.095 g (0.72 mmol), and the yield of ammonium sulfate was calculated to be 81.7% based on sodium nitrate.

### Control of Hydrogen Pressure

### Example 1-2

The reactions were conducted in the same manner as in Example 1-1 except that it was carried out under a hydrogen pressure of 1.0 MPa. After the reactions, precipitates and solids obtained from the remaining solution were identified as sodium bicarbonate and sodium nitrate by PXRD analysis. The yield of sodium bicarbonate was calculated to be 51.1% based on sodium nitrate. Sulfuric acid and acetone were added to the remaining solution, followed by separation and drying to obtain a small amount of white ammonium sulfate powder.

### Example 1-3

The reactions were conducted in the same manner as in Example 1-1 except that it was carried out under a hydrogen pressure of 3.0 MPa. After the reactions, precipitates and solids obtained from the remaining solution were identified as sodium bicarbonate by PXRD analysis. The yield of sodium bicarbonate was calculated to be 89.1% based on sodium nitrate. Sulfuric acid and acetone were added to the remaining solution, followed by separation and drying to obtain a small amount of white ammonium sulfate powder.

### Control of Reaction Temperature

### Example 1-4

The reactions were conducted in the same manner as in Example 1-1 except that it was carried out at 80° C. After the reactions, precipitates and solids obtained from the remaining solution were identified as sodium bicarbonate and sodium nitrate by PXRD analysis. The yield of sodium bicarbonate was calculated to be 71.1% based on sodium nitrate. Sulfuric acid and acetone were added to the remaining solution, followed by separation and drying to obtain a small amount of white ammonium sulfate powder.

### Example 1-5

The reactions were conducted in the same manner as in Example 1-1 except that it was carried out at 120° C. After the reactions, precipitates and solids obtained from the remaining solution were identified as sodium bicarbonate by PXRD analysis. The yield of sodium bicarbonate was calculated to be 91.1% based on sodium nitrate. Sulfuric acid and acetone were added to the remaining solution, followed by separation and drying to obtain a small amount of white ammonium sulfate powder.

### Control of Solvent Volume

### Example 1-6

The reactions were conducted in the same manner as in Example 1-1 except that it was carried out by using 0.1 mL of distilled water as a solvent. After the reactions, precipitates and solids obtained from the remaining solution were identified as sodium bicarbonate and sodium nitrate by PXRD analysis. The yield of sodium bicarbonate was calculated to be 80.1% based on sodium nitrate. Sulfuric acid and acetone were added to the remaining solution, followed by separation and drying to obtain a small amount of white ammonium sulfate powder.

### Example 1-7

The reactions were conducted in the same manner as in Example 1-1 except that it was carried out by using 2.5 ml of distilled water as a solvent. After the reactions, precipitates and solids obtained from the remaining solution were identified as sodium bicarbonate and sodium nitrate by PXRD analysis. The yield of sodium bicarbonate was calculated to be 10.5% based on sodium nitrate. Sulfuric acid and acetone were added to the remaining solution, followed by separation and drying to obtain a small amount of white ammonium sulfate powder,

### Change of Catalyst Type

### Example 1-8

The reactions were conducted in the same manner as in Example 1-1 except that it was carried out by using ruthenium powder (7.6 mg, 0.075 mmol) as a catalyst. After the reactions, precipitates and solids obtained from the remaining solution were identified as sodium bicarbonate and sodium nitrate by PXRD analysis. The yield of sodium bicarbonate was calculated to be 25.1% based on sodium nitrate. Sulfuric acid and acetone were added to the remaining solution, followed by separation and drying. As a result, very little white powder was obtained.

### Example 1-9

The reactions were conducted in the same manner as in Example 1-1 except that it was carried out by using platinum powder (14.6 mg, 0.075 mmol) as a catalyst. After the reactions, precipitates and solids obtained from the remaining solution were identified as sodium bicarbonate and sodium nitrate by PXRD analysis. The yield of sodium bicarbonate was calculated to be less than 1.0% based on sodium nitrate. Sulfuric acid and acetone were added to the remaining solution, followed by separation and drying. However, little white powder was obtained.

### Example 1-10

The reactions were conducted in the same manner as in Example 1-1 except that it was carried out by using palladium powder (8.0 mg, 0.075 mmol) as a catalyst. After the reactions, precipitates and solids obtained from the remaining solution were identified as sodium bicarbonate and sodium nitrate by PXRD analysis. The yield of sodium bicarbonate was calculated to be 7.1% based on sodium nitrate. Sulfuric acid and acetone were added to the remaining solution, followed by separation and drying. However, little white powder was obtained.

### Addition of Additive

### Example 1-11

The reactions were conducted in the same manner as in Example 1-1 except that it was carried out by adding 0.5 mL of 1 M NaOH solution as an additive. After the reactions, precipitates and solids obtained from the remaining solution after the reactions were identified as sodium bicarbonate by PXRD analysis. The yield of sodium bicarbonate was calculated to be 88.7% based on sodium nitrate. Sulfuric acid and acetone were added to the remaining solution, followed by separation and drying to obtain white ammonium sulfate powder.

### Example 2-1

After 0.284 g (2.00 mmol) of sodium sulfate (Na₂SO₄), 0.523 g (2.00 mmol) of barium nitrate (Ba(NO₃)₂), 20 mg (0.15 mmol) of HₓRuO₂, and 4 mL of distilled water were placed in a hydrothermal reactor, the hydrothermal reactor was filled with carbon dioxide at a pressure of 1.0 MPa and hydrogen at a pressure of 4.0 MPa and the reactions were conducted at 100° C. for 6 hours. After the reactions were completed, the hydrothermal reactor was cooled to room temperature, and the resulting precipitates and the remaining solution were separated.

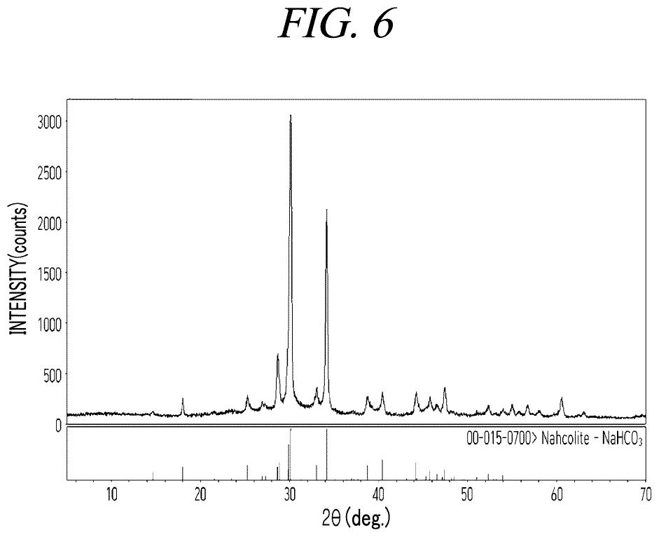

Crystals obtained by drying the remaining solution were identified as NaHCO₃ by PXRD analysis (see FIG. 6). The amount of NaHCO₃ obtained was 0.334 g (3.98 mmol), and the yield of NaHCO₃ was calculated to be 99.4% based on Na₂SO₄.

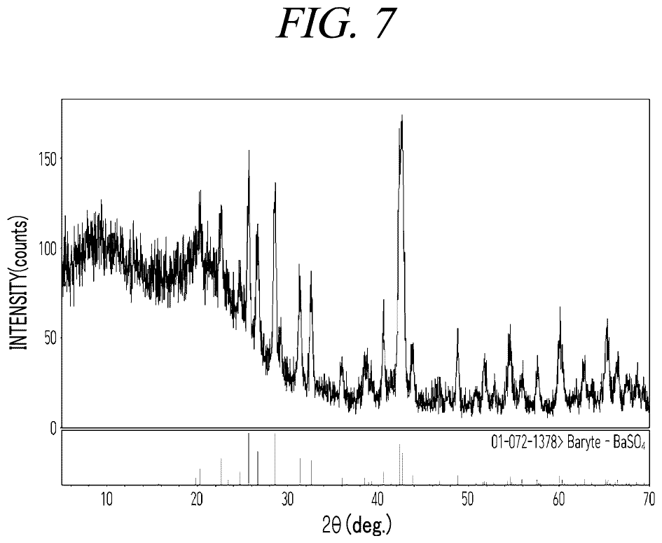

The precipitates were identified as barium sulfate (BaSO₄) by PXRD analysis (see FIG. 7). The amount of BaSO₄ obtained was 0.448 g (1.92 mmol), and the yield of BaSO₄ was calculated to be 96.0% based on Ba(NO₃)₂.

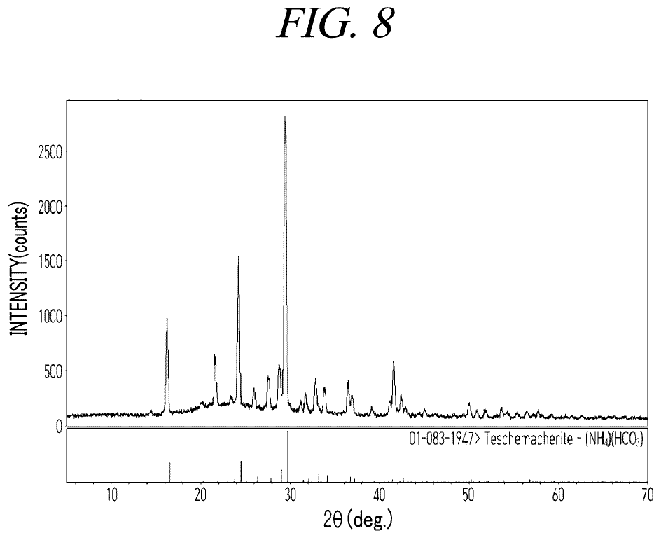

The remaining solution after the reactions was analyzed by UV-vis spectroscopy. As a result, no nitrate ions (NO₃⁻ and NO₂⁻) were detected, which indicates that all nitrate ions in the reactant were converted into ammonia or nitrogen. Acetone was added to the remaining solution, followed by separation and drying of the obtained precipitates to obtain white powder. The white powder was identified as ammonium bicarbonate (NH₄HCO₃) by PXRD analysis (see FIG. 8).

### Example 2-2

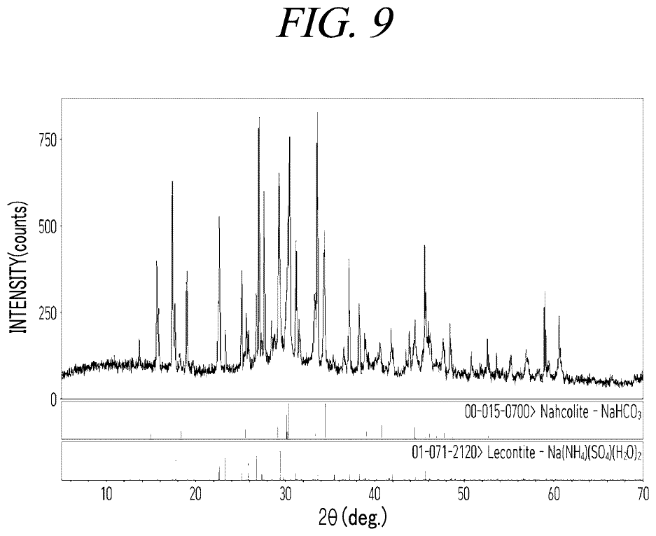

The reactions were conducted in the same manner as in Example 2-1 except that it was carried out by using 4 mL of 1.0 M nitric acid as a reactant. After the reactions, the hydrothermal reactor was cooled to room temperature, and the catalyst and the products were separated. The products were identified as NaHCO₃ and Na(NH₄)SO₄·2H₂O by PXRD analysis (see FIG. 9).

### Example 2-3

The reactions were conducted in the same manner as in Example 2-1 except that it was carried out by using 0.234 g (4.00 mmol) of sodium chloride (NaCl) and 0.679 g (4.00 mmol) of silver nitrate (AgNO₃) as reactants. After the reactions, the hydrothermal reactor was cooled to room temperature, and the precipitates and the remaining solution were separated.

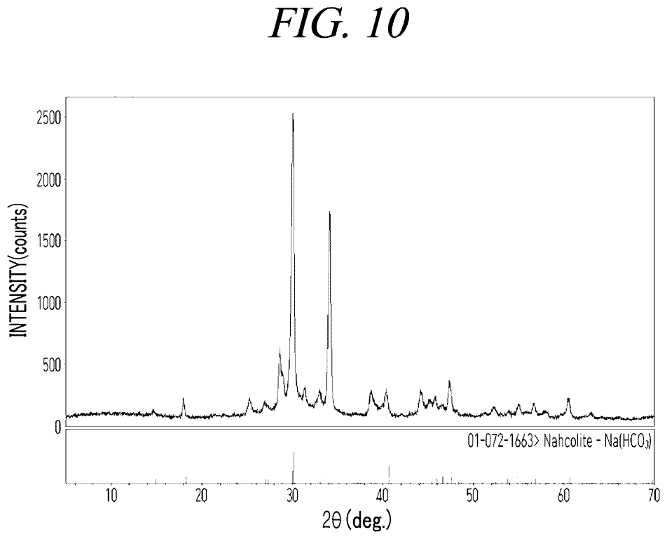

Crystals obtained by drying the remaining solution were identified as NaHCO₃ by PXRD analysis (see FIG. 10). The amount of NaHCO₃ obtained was 0.332 g (3.95 mmol), and the yield of NaHCO₃ was calculated to be 98.8% based on NaCl.

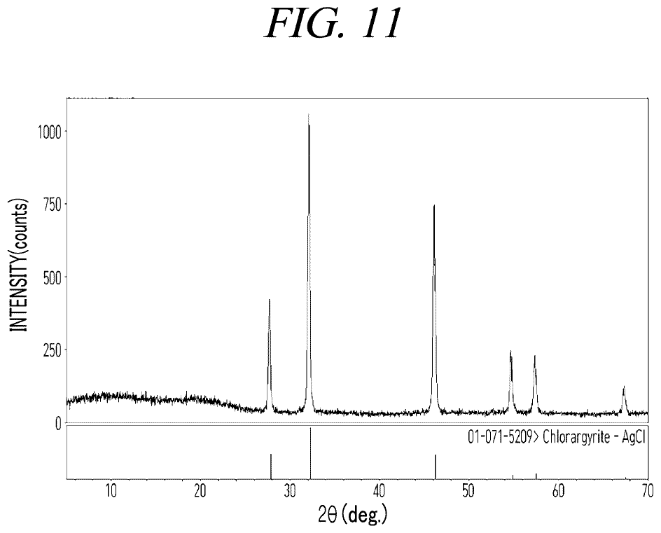

The precipitates were identified as silver chloride (AgCl) by PXRD analysis (see FIG. 11). The amount of AgCl obtained was 0.548 g (3.82 mmol), and the yield of AgCl was calculated to be 95.6% based on AgNO₃.

### Example 2-4

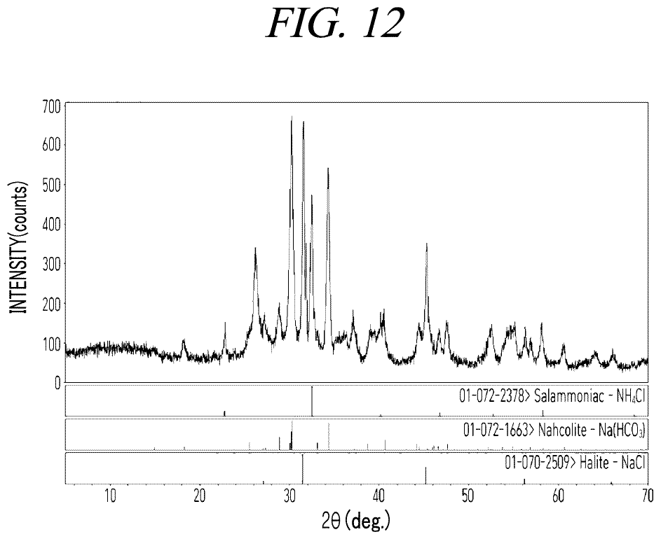

The reactions were conducted in the same manner as in Example 2-3 except that it was carried out by using 4 mL of 1.0 M nitric acid as a reactant. After the reactions, the hydrothermal reactor was cooled to room temperature, and the catalyst and the products were separated. The products were identified as NaHCO₃, NH₄Cl and NaCl by PXRD analysis (see FIG. 12).

### Example 2-5

The reactions were conducted in the same manner as in Example 2-1 except that it was carried out by using 0.568 g (2.00 mmol) of sodium silicate (Na₂SiO₃·9H₂O) and 4 mL of 1.0 M nitric acid as a reactant. After the reactions, the hydrothermal reactor was cooled to room temperature, and the precipitates and the remaining solution were separated.

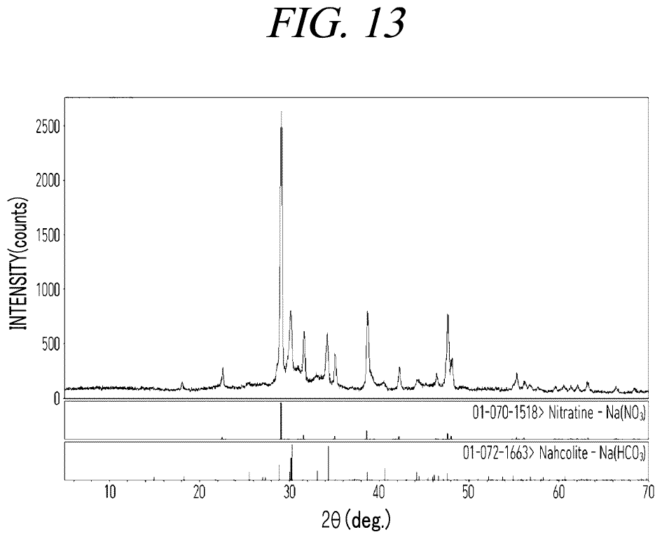

Crystals obtained by drying the remaining solution were identified as NaHCO₃ and NaNO₃ by PXRD analysis (see FIG. 13). The amount of the crystals obtained was 0.339 g, the yield of the sodium was more than 99%, and the yield of the NaHCO₃ was 25.0%.

The precipitates were identified as amorphous SiO₂ and catalyst HₓRuO₂ by PXRD analysis. The amount of precipitates obtained was 0.140 g, and the yield of the precipitates was calculated to be 99.9%.

### Example 2-6

The reactions were conducted in the same manner as in Example 2-1 except that it was carried out by using 0.484 g (2.00 mmol) of sodium molybdate (Na₂MoO₄·2H₂O) and 4 mL of 1.0 M nitric acid as reactants. After the reactions, the hydrothermal reactor was cooled to room temperature, and the precipitates and the remaining solution were separated.

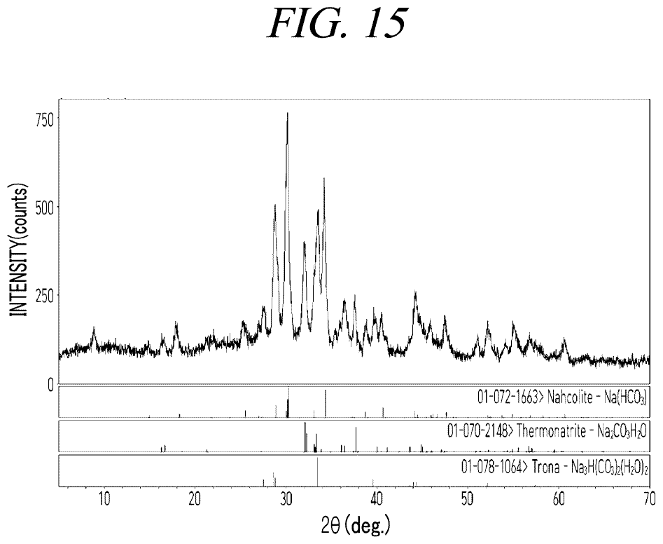

Crystals obtained by drying the remaining solution were identified as sodium carbonate (NaHCO₃, Na₂CO₃H₂O, and Na₃H(CO₃)₂(H₂O)₂) by PXRD analysis (see FIG. 15). The amount of crystals obtained was 0.319 g, and the yield of sodium was more than 99.9%.

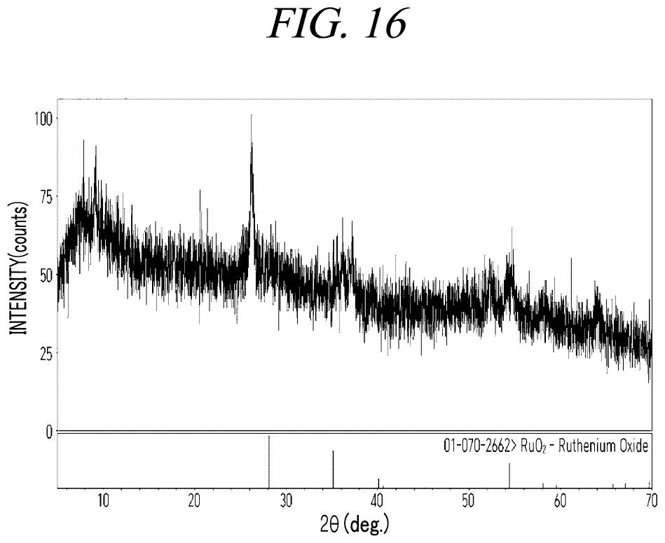

The precipitates were identified as amorphous (NH₄)₂MoO₄ and catalyst HₓRuO₂ by PXRD analysis. The amount of precipitates obtained was 0.388 g, and the yield of the precipitates was 99.0% (see FIG. 16).

### Control of Reaction Gas Pressure

### Example 2-7

The reactions were conducted in the same manner as in Example 2-1 except that it was carried out under a carbon dioxide pressure of 0.5 MPa and a hydrogen pressure of 2.0 MPa. The yield of NaHCO₃ obtained after the reactions was 68.7%.

### Example 2-8

The reactions were conducted in the same manner as in Example 2-1 except that it was carried out under a carbon dioxide pressure of 2.0 MPa and a hydrogen pressure of 3.0 MPa. The yield of NaHCO₃ obtained after the reactions was 98.6%.

### Control of Reaction Temperature

### Example 2-9

The reactions were conducted in the same manner as in Example 2-1 except that it was carried out at 80° C. The yield of NaHCO₃ obtained after the reactions was 60.8%.

### Example 2-10

The reactions were conducted in the same manner as in Example 2-1 except that it was carried out at 120° C. The yield of NaHCO₃ obtained after the reactions was 99.1%.

### Control of Solvent Volume

### Example 2-11

The reactions were conducted in the same manner as in Example 2-1 except that it was carried out by using 2.0 ml of distilled water as a solvent. The yield of NaHCO₃ obtained after the reactions was 88.0%.

### Example 2-12

The reactions were conducted in the same manner as in Example 2-1 except that it was carried out by using 8.0 ml of distilled water as a solvent. The yield of NaHCO₃ obtained after the reactions were 71.4%.

### Change of Catalyst Type

### Example 2-13

The reactions were conducted in the same manner as in Example 2-1 except that it was carried out by using ruthenium powder (15.2 mg, 0.15 mmol) as a catalyst. The yield of NaHCO₃ obtained after the reactions was less than 5%, with only a very small amount obtained.

### Example 2-14

The reactions were conducted in the same manner as in Example 2-1 except that it was carried out by using platinum powder (29.3 g, 0.15 mmol) as a catalyst. The yield of NaHCO₃ obtained after the reactions was less than 5%, with only a very small amount obtained.

### Example 2-15

The reactions were conducted in the same manner as in Example 2-1 except that it was carried out by using palladium powder (16.0 mg, 0.15 mmol) as a catalyst. The yield or NaHCO₃ obtained after the reactions was 11/8%.

The above description of the present disclosure is provided for the purpose of illustration, and it would be understood by a person with ordinary skill in the art that various changes and modifications may be made without changing technical conception and essential features of the present disclosure. Thus, it is clear that the above-described examples are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure

What is claimed is:

1. A method of preparing sodium bicarbonate, comprising:
obtaining sodium bicarbonate through catalytic reactions of a sodium-containing substance, nitric acid or nitrate, carbon dioxide, and hydrogen.

2. The method of preparing sodium bicarbonate of claim 1,
wherein the sodium-containing substance includes at least one selected from sodium ions, sodium salts, sodium-containing composite oxides, and sodium-containing ores.

3. The method of preparing sodium bicarbonate of claim 2,
wherein the sodium salts include at least one selected from NaNO₃, Na₂SO₄ and NaCl, and
the sodium-containing composite oxides and/or the sodium-containing ores include at least one selected from Na₂SiO₃, Na₂MoO₄, and Na₃VO₄.

4. The method of preparing sodium bicarbonate of claim 1,
wherein the nitrate includes at least one selected from NaNO₃, Ca(NO₃)₂, Ba(NO₃)₂, Pb(NO₃)₂, and AgNO₃.

5. The method of preparing sodium bicarbonate of claim 1,
wherein the catalyst is selected from metals, alloys, or oxides, including at least one selected from titanium (Ti), vanadium (V), chromium (Cr), manganese (Mn), iron (Fe), cobalt (Co), nickel (Ni), copper (Cu), zinc (Zn), molybdenum (Mo), indium (In), tin (Sn), phosphorus (P), aluminum (Al), silicon (Si), ruthenium (Ru), rhodium (Rh), palladium (Pd), silver (Ag), tungsten (W), rhenium (Re), osmium (Os), iridium (Ir), platinum (Pt), and gold (Au).

6. The method of preparing sodium bicarbonate of claim 5,
wherein the catalyst includes a ruthenium oxide catalyst that is represented by Chemical Formula I:
HₓRuO₂; [Chemical Formula I]
wherein in Chemical Formula I, 0<x≤4.

7. The method of preparing sodium bicarbonate of claim 1,
wherein the catalytic reactions are conducted in a hydrothermal reactor.

8. The method of preparing sodium bicarbonate of claim 1,
wherein reactants of the catalytic reactions further include a solvent.

9. The method of preparing sodium bicarbonate of claim 8,
wherein the solvent is selected from distilled water, methanol, and ethanol.

10. The method of preparing sodium bicarbonate of claim 1,
wherein a pressure ratio of the carbon dioxide to the hydrogen (carbon dioxide:hydrogen) is from 1:1 to 1:50.

11. The method of preparing sodium bicarbonate of claim 1,
wherein the catalytic reactions are conducted at a temperature of from 20° C. to 200° C.

12. The method of preparing sodium bicarbonate of claim 1,
wherein reactants of the catalytic reactions further include an additive.

13. The method of preparing sodium bicarbonate of claim 12,
wherein the additive includes at least one selected from NaOH, KOH, LiOH, Ba(OH)₂, Ca(OH)₂, RbOH, CsOH, Sr(OH)₂, CH₃NH₂, C₂H₅NH₂, Mg(OH)₂, and Al(OH)₃.

14. The method of preparing sodium bicarbonate of claim 1,
wherein a byproduct in addition to sodium bicarbonate is further prepared by the method of preparing sodium bicarbonate.

15. The method of preparing sodium bicarbonate of claim 14,
wherein the byproduct includes at least one selected from BaSO₄, CaSO₄, AgCl, NaCl, NaNO₃, SiO₂, ammonia, and an ammonium compound.

16. The method of preparing sodium bicarbonate of claim 15,
wherein the ammonium compound includes at least one selected from NH₄HCO₃, (NH₄)₂SO₄, (NH₄)HSO₄, Na(NH₄)SO₄·2H₂O, NH₄NO₃, CH₃COONH₄, (NH₄)₂CO₃, NH₄HCO₃, NH₄Cl, and (NH₄)₂MoO₄.

17. A ruthenium oxide catalyst that is used in the method of claim 1, represented by Chemical Formula I, and has a monoclinic structure:
HₓRuO₂; [Chemical Formula I]
wherein in Chemical Formula I, 0<x≤4.

18. The ruthenium oxide catalyst of claim 17,
wherein the diffraction peaks of the ruthenium oxide may be observed at respective positions corresponding to incident angles (2θ) of 18.38°<2θ<18.42°, 25.45°<2θ<25.51°, 26.26°<2θ<26.32°, 33.45°<2θ<33.51°, 35.28°<2θ<35.34°, 36.24°<2θ<36.30°, 37.32°<2θ<37.38°, 39.55°<2θ<39.61°, 40.61°<2θ<40.67°, 41.46°<2θ<41.52°, 49.17°<2θ<49.23°, 52.31°<2θ<52.37°, 54.03°<2θ<54.09°, 54.70°<2θ<54.76°, 55.95°<2θ<56.01°, 59.97°<2θ<60.03°, 60.40°<2θ<60.46°, 61.92°<2θ<61.98°, 63.94°<2θ<64.00°, 65.79°<2θ<65.85° and 69.13°<2θ<69.19° as determined by X-ray powder diffraction measurement (Cu Kα rays).

19. The ruthenium oxide catalyst of claim 17,
wherein the ruthenium oxide catalyst has a structure of a monoclinic space group P2₁/c, C2/m, P2/c, C2/c, P2/m or P2₁/m.

20. The ruthenium oxide catalyst of claim 19,
wherein the monoclinic structure has lattice constants of 5 Å≤a≤6 Å, 5 Å≤b≤6 Å and 5 Å≤c≤6 Å, and a beta (β) angle of 110° to 120°.

21. The ruthenium oxide catalyst of claim 19,
wherein the monoclinic structure has lattice constants of a=5.3533 Å, b=5.0770 Å, and c=5.3532 Å, and a beta (β) angle of 115.9074°.
